(19) United States
(12) Patent Application Publication
(10) Pub. No.: US 2018/0373931 A1
(43) Pub. Date: Dec. 27, 2018

(54) IMAGE RECOGNITION SYSTEM FOR ROOF DAMAGE DETECTION AND MANAGEMENT

(71) Applicant: PANTON, INC., Houston, TX (US)

(72) Inventor: Saishi Frank LI, Sugar Land, TX (US)

(21) Appl. No.: 16/013,418

(22) Filed: Jun. 20, 2018

Related U.S. Application Data
(60) Provisional application No. 62/522,945, filed on Jun. 21, 2017.

(51) Int. Cl. G06K 9/00; G06Q 40/08; G06T 17/05; B64C 39/02; G05D 1/00

(52) U.S. Cl. CPC G06K 9/00637; G06Q 40/08; G06T 17/05; B64C 2201/123; G05D 1/0094; B64C 2201/127; B64C 39/024

(57) ABSTRACT

Certain aspects of the present disclosure relate to methods and apparatus for applying image analysis and machine learning algorithms to a collection of 2-D aerial images into one or more of a claims report. For example, a method may include generating an insurance analytics project based on a user input, acquiring image data of the structure based on the insurance analytics project, generating a 3-D model of the structure based on the image data, calculating measurements of the structure based on the 3-D model and image data, detecting one or more features of the structure using one or more of the measurements, the 3-D model, and the image data, and generating a report based on one or more of the user input, the image data, the 3-D model, the measurements, and the one or more features.

### CLAIM OF PRIORITY UNDER 35 U.S.C. § 119

The present application for patent claims benefit of U.S. Provisional Patent Application Ser. No. 62/522,945, filed Jun. 21, 2017, which is expressly incorporated by reference herein.

### BACKGROUND

### Field of the Disclosure

The present disclosure relates generally to image processing systems, and more particularly, to methods and apparatus for detecting and managing roof damage images and claims.

### Description of Related Art

Currently, the process of handling insurance claims for roof structure damage can be a time intensive and labor intensive process. For example, if a request is made, an insurance carrier will contact and request an adjuster to travel and acquire images of the select structure. The adjuster may then travel to the structure and proceed to scale the structure to acquire images. These images are then taken back and looked at by the adjuster who makes decisions based on the onsite inspection and uses the images as supporting visual aids to show examples of the damage. The adjuster may then send his analysis to the insurance carrier. The insurance carrier may then have one or more people review the adjuster's analysis and estimate roughly the cost to repair and other items relating to generating a report. This process currently can take weeks to complete. Additionally, the process of handling insurance claims for roof structure damage in this manner may also lack consistency and accuracy in the results generated. Further, the overall cost can be high due to the many man hours involved.

As the demand for more efficient and accurate methods and systems continues to increase, there exists a desire for use of and further improvements in image acquisition, processing, and management and usage of the image data.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages.

Certain aspects provide a computer-implemented method for applying insurance analytics to a structure to generate a report. The method generally includes generating an insurance analytics project based on a user input, acquiring image data of the structure based on the insurance analytics project, generating a 3-D model of the structure based on the image data, calculating measurements of the structure based on the 3-D model and image data, detecting one or more features of the structure using one or more of the measurements, the 3-D model, and the image data, and generating a report based on one or more of the user input, the image data, the 3-D model, the measurements, and the features.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example of a current arrangement of an insurance claim system.

FIG. 2 is a block diagram illustrating an example of an insurance data analytics platform system, in accordance with certain aspects of the present disclosure.

FIG. 3 illustrates example operations for applying insurance analytics to a structure to generate a report, in accordance with aspects of the present disclosure.

FIG. 4 is a diagram illustrating an example of acquiring image data of a structure using a UAV, in accordance with certain aspects of the present disclosure.

FIG. 5 illustrates an example of generating a 3-D model of a structure and a 3-D model GUI interface and calculating measurements of the 3-D model, in accordance with aspects of the present disclosure.

FIG. 6 illustrates an example of a damage report and a damage report GUI, in accordance with aspects of the present disclosure.

FIG. 7 illustrates an example of a perimeter flight path for a UAV around a structure, in accordance with aspects of the present disclosure.

FIG. 8 illustrates examples of multi-perimeter flight patterns for a UAV, in accordance with aspects of the present disclosure.

FIG. 9 illustrates an example of a zig-zag flight pattern for a UAV, in accordance with aspects of the present disclosure.

FIG. 10 illustrates an example of an overlap image acquisition scheme when in a zig-zag flight pattern, in accordance with aspects of the present disclosure.

FIG. 11 illustrates an example of a close-up flight pattern of a UAV over a structure, in accordance with aspects of the present disclosure.

To facilitate understanding, identical reference numerals have been used, where possible, to designate identical elements that are common to the figures. It is contemplated that elements described in one aspect may be beneficially utilized on other aspects without specific recitation.

### DETAILED DESCRIPTION

Aspects of the present disclosure provide apparatus, methods, processing systems, and computer readable mediums for applying advanced image analysis and machine learning algorithms to a collection of 2-D aerial images into one or more of a claims report, a roof measurement report, and a record of the structure that was photographed through a central platform that provides central data analytics and management.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure described herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

### Example Insurance Claim Process

The current arrangement of an insurance claim process involves each party that is part of the process to be part of a decentralized ad-hoc process, an example of which is shown in FIG. 1. Specifically, as shown in FIG. 1, a process and/or system 100 for handling an insurance claim process from inspection to completion may involve a number of different parties. As shown, for example, an insurance carrier 102, an adjuster 104, a structure owner and/or policy holder 106, a contractor and/or roofer 108, and one or more third party information providers 110 may be involved in the process.

The process may being when a structure owner 104 or policy holder notices or believes that damage has been incurred to the structure. The owner 104 may issue a claim that is sent to insurance carrier 102. Upon receipt of the claim request, the carrier 103 may contact an adjuster 104 who then communicates with the owner 104 to gain access to the structure for inspection. The adjuster may also communicate with third parties 110 for additional information regarding the structure. The adjuster 104 may then submit their finding to the insurance carrier 102. A structure owner 106 may then contact the insurance carrier 103 and/or adjuster to possibly see some of the results of the report. In some cases these reports may not be shared with the policy holder.

Further, the insurance carrier 102, with the adjuster's report in hand, may then contact a contractor or roofer 108 to see about scheduling a repair. In other cases, the insurance carrier 102 may instead leave that to a structure owner 106 to find and contract with a roofer 108. Overall, this arrangement can prove to be burdensome, confusing, inefficient, and inaccurate at times with many points at which information may be lost, mishandled, or delayed. These issues may negatively affect all parties.

### Example Insurance Data Analytics Platform and Method

Thus, in accordance with one or more cases as described herein, an insurance data analytics platform may be provided that can alleviate and possibly altogether solve or eliminate many of the issues that currently exist in the current processes.

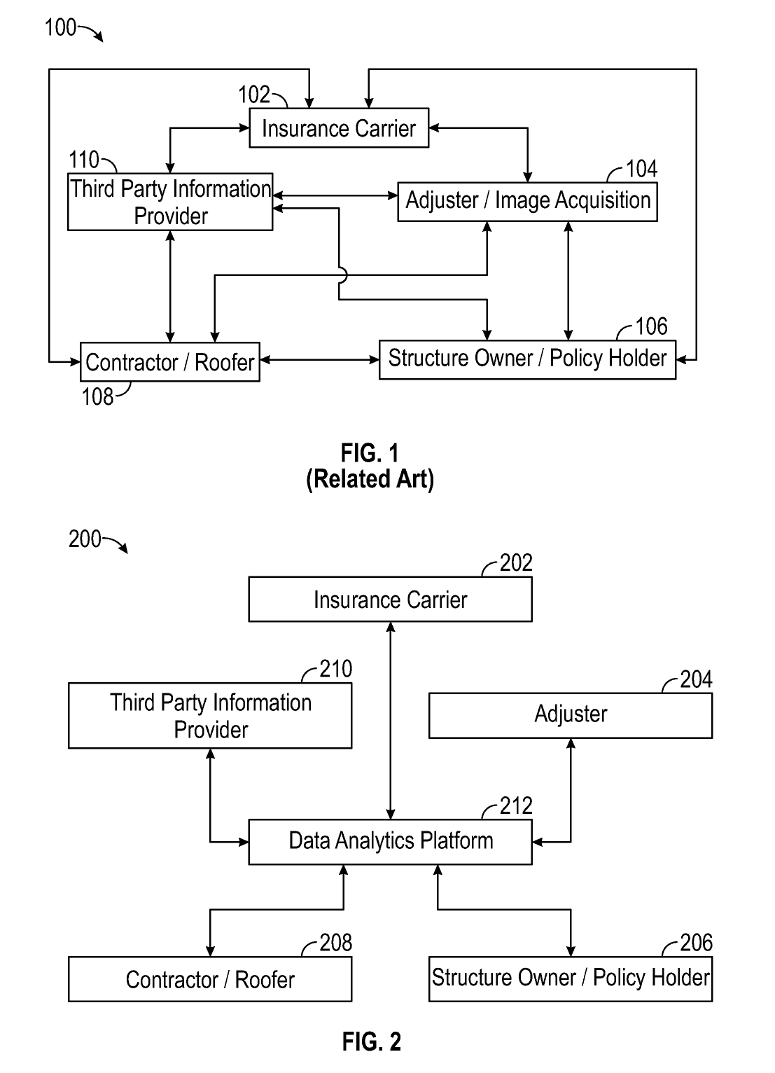

FIG. 2 shows an example of an insurance data analytics platform system 200, in accordance with certain aspects of the present disclosure. The insurance data analytics platform 200 may include a central data analytics platform 212. This data analytics platform 212 may be provided at a central or distributed server that may be accessed by any of the parties through any one or more known digital means such as a web portal, an installed computer application, a phone application, or through passive entry such as simply submitting an emails with information to be entered into the system. Other cloud related implementations may be implements to house the insurance data analytics platform 200 which provides the storage and algorithms and interfaces for receiving, centralizing, analyzing, and generating new data that can be provided to one or more of the parties. Additionally, the insurance data analytics platform 200 may specially tailor the access and visual experiences of each type of user based on their preferences and access rights.

For example, the insurance data analytics platform system 200 may include not only a data analytics platform 212 but may also include communicatively connected users including an insurance carrier 202, an adjuster 204, a structure owner and/or policy holder 206, a contractor and/or roofer 208, and a third party information provider 210. As shown, each of the parties communicates directly with the data analytics platform 212. Accordingly, this arrangement allows for a centralized control and uniform and efficient approach to the claims process. For example, any party can begin the claims process that is granted the ability to do so. This ability allows third party information providers 210 to start claims processes rather than just insurance carriers 202 and policy holders 206. This may be useful, for example, if the third party 210 is a weather service who detects that severe weather may have damaged specific structures. In particular, the insurance data analytics platform system 200 may allow the third party 210 to begin the claim process for these specific structures that may have been damaged by the severe weather.

According to another example, a roofer 208 may also start a process on behalf of a structure owner 206, who is a policy holder, as a way of simplifying the process for the structure owner 206. Further, even an adjuster 204, may be granted to ability to start a claim request. For example, an adjuster 204 may see the third party 210 information through the data analytics platform and determine that based on the body of information a request may be warranted. Further, a policy holder 206 may also see information for one or more properties that the policy holder 206 may not be near geographically that may allow the policy holder to determine that damage had been incurred and that a claim should be started.

Further, the centralized nature of the system 200 may also allow for preventive measures to be done such as pre damage inspections when policies are first issued which may provide a body of image data and other information that may be used in the event later that damage is incurred or a claim purporting damage is requested.

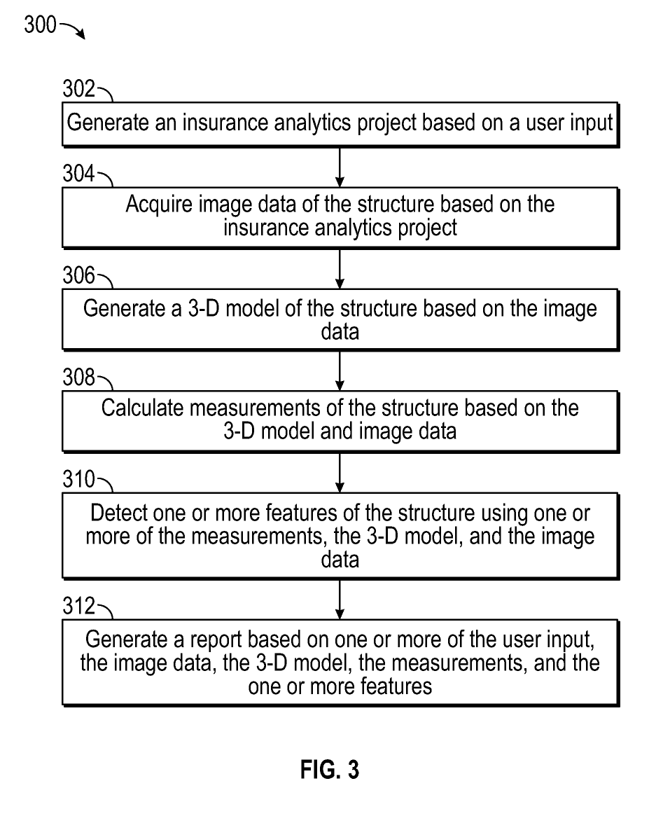

FIG. 3 illustrates example operations 300 for applying insurance analytics to a structure to generate a report, in accordance with aspects of the present disclosure.

In this example, operations 300 begin, at block 302, with generating an insurance analytics project based on a user input. The operations 300 also include, at block 304, acquiring image data of the structure based on the insurance analytics project. Further, the operations 300 include, at block 306, generating a 3-D model of the structure based on the image data. At block 308, the operations 300 include calculating measurements of the structure based on the 3-D model and image data. Additionally the operations 300 include, at block 310, detecting one or more features of the structure using one or more of the measurements, the 3-D model, and the image data. Finally, the operations 300 include, at block 312, generating a report based on one or more of the user input, the image data, the 3-D model, the measurements, and the features.

According to one or more cases generating the insurance analytics project may include receiving a request to generate an insurance analytics project from a user, posting the request via a request interface, and receiving an acceptance indication of the request for the insurance analytics project from an adjuster through the request interface. The user may be at least one of an insurance carrier, the adjuster, a home owner, a policy holder, a roofer, a contractor, or a weather service provider. According to one example, the user input from the weather service provider includes weather data including one or more of hail damaged areas, high wind areas, severe weather areas, weather severity information, weather date occurrence, and weather duration. The method may further include assigning the insurance analytics project to the adjuster based on at least an acceptance indication.

Further, in one or more cases, receiving the request may include receiving a user input through a web portal that includes an insertion GUI that provides input areas for a user to enter information including an address and a job type. In other cases, receiving the request may include receiving a user input in the form of an email that comprises parameters for generating the insurance analytics project.

In accordance with one or more cases, acquiring image data of the structure based on the insurance analytics project may include activating an unmanned aerial vehicle (UAV) that includes an image capture device and a communication system for transferring captured image data, flying the UAV over the structure and collecting image data, and transmitting the image data to a central storage and processing entity.

Further, according to one or more cases, collecting image data may include processing the image data by using a processing device on the UAV as the image data is captured. Flying the UAV over the structure and collecting image data may include flying to a top position over the structure, flying along a perimeter path around the structure at a lower altitude than the top position, flying along a zig-zag pattern over the structure at a lower altitude than the perimeter path, and flying along a close-up route near the structure and collecting one or more of images or a video while flying.

According to another one or more cases, flying the UAV over the structure and collecting image data may include flying to a top position that is around 400 or more feet over the structure and acquiring an overall top-down image of the structure from the top position. In one example, the UAV flies at a height between 300 feet and 1,000 feet above the structure while acquiring images. Flying the UAV over the structure and collecting image data may also include flying along a perimeter of the structure around 60 feet off the ground, and collecting a plurality of birds-eye-view images. Further, in one or more cases, flying the UAV over the structure and collecting image data further includes flying in a zig-zag pattern over the structure between 30 and 60 feet off the ground, and collecting a plurality of zig-zag images. Flying the UAV over the structure and collecting image data may further include flying 6 to 10 feet from the structure along the structure, and collecting a plurality of close-up images of the structure.

The plurality of close-up images may include images of the entire roof of the structure when the structure is a home residence. Alternatively, the plurality of close-up images may include images of select portions of the roof of the structure when the structure is a commercial building. The select portions may include one or more of roof seams, roof vents, roof attached HVAC units, and any other items found on the roof.

In accordance with one or more cases, acquiring image data of the structure based on the insurance analytics project may include acquiring image data using a portable handheld mobile device that includes an image sensor and a communication system. The mobile device may include a GUI has a plurality of input screens including: a job selection screen that allows a user to select a job from among a plurality of available jobs; an image type capture screen that provides a list of image types to capture for a selected job; an image preview screen for each of the image types that shows a preview of any images that have been captured or an indicator that indicates no image has yet been captured; and an auxiliary input screen where a user can type in additional information including one or more of location, time, materials, conditions of structure, or image notes. The image data may include one or more of downspouts, windows, doors, walls, and AC units.

According to one or more cases, the user input may include one or more of home materials, age of home, components of home, previous real-estate transaction information, city permit information, city inspection information, and other related information about the structure and structure history including historical photos or other such items. The image data that is collected may include one or more of digital images, thermal images, video, infrared images, or multispectral images.

In accordance with one or more cases, generating the 3-D model of the structure based on the image data may include collecting the image data and user input at a central storage and processing entity, selecting one or more images from the image data for generating the 3-D model of the structure, and generating the 3-D model using the selected images.

Generating the 3-D model using the selected images may include generating a point cloud based on one or more of the selected images, and texturing and coloring the point cloud using one or more of the selected images. Other modeling techniques may also be used in accordance with one or more embodiments.

In one or more cases, calculating measurements of the structure may include calculating measurements that include one or more of dimensions of the roof of the structure, pitch of each planar portion of the roof of the structure, seam location, roof materials, one or more panels installed on the roof, or any other measured metric relating to the structure.

According to some cases, detecting the one or more features of the structure may include detecting one or more features that include one or more of damage points on the roof of the structure, damage type of each damage point, and damage point properties. In other cases detecting the one or more features of the structure may include detecting one or more features that include solar panels, vents, AC units, gutters, or other items. Further, detecting the one or more features of the structure may include training a deep learning model to identify and classify damages to the structure, wherein the deep learning model is trained using at least one or more sets of images that each depicts a distinct type of structure damage and a set of images depicting undamaged structures.

Generating an insurance report may include, for example, identifying one or more issues with the structure corresponding to the features detected, and determining a scope of the issues of the structure, wherein the scope includes an estimation of the types of repairs and costs for those repairs for remedying the one or more issues. In other cases, generating the report may include populating the report with one or more of structure conditions including a damage report, a weather report, an image report showing images that correspond to damage points in the damage report, a scope of work report that includes an estimation of the types of repairs and costs for those repairs, and a measurement report that shows the measurements overlaid on the 3-D model. Further, generating the report may include integrating and matching additional information with the image data, wherein the additional information includes information provide by one or more roofers including bid amounts for different types of repairs and materials.

According to one or more cases, generating the report may include generating an image report that includes images showing damage to the roof of the structure. Further, generating the image report may include selecting an image that corresponds to one or more of the features detected, adding one or more graphical indications to the image to call out damage points, and adjusting image properties to enhance the one or more features for improved visual identification. The method may further include displaying related images to the image showing damage. Further, generating the image report may include superimposing the images showing damage onto the 3-D model. According to one or more cases, the method may include converting the report into an insurance claim that includes an identification of one or more issues and a calculated amount to address the issues.

### Example Computer-Implemented System Elements and Method Elements for Applying Insurance Data Analytics

A graphical user interface (GUI) for generating an insurance analytics project may be provided, in accordance with certain aspects of the present disclosure. The GUI may include a first window that provides a number of entry fields that a user can fill out. For example, the window includes Tillable fields for an address, insurance information, policy holder information, structure information, and other fields. Additionally, the GUI also may include a second window that shows a list of insurance analytics projects. This second window may be shown to an insurance carrier so they can monitor and track the current pipeline of active claims. An adjuster may be shown a similar second window that can be populated with, for example, the current projects assigned to an adjuster or a list of projects the adjuster may select from. Further, this list shown in the second window may be shown to a policy holder to show them where in a queue of projects they are so they can understand when they can expect service and also so they can see that status and progress of their request.

According to one or more examples, a GUI may be used to generate the insurance analytics project by providing the ability for one user to upload a request such as a policy holder while also allowing another user, such as an insurance carrier, to accept the request.

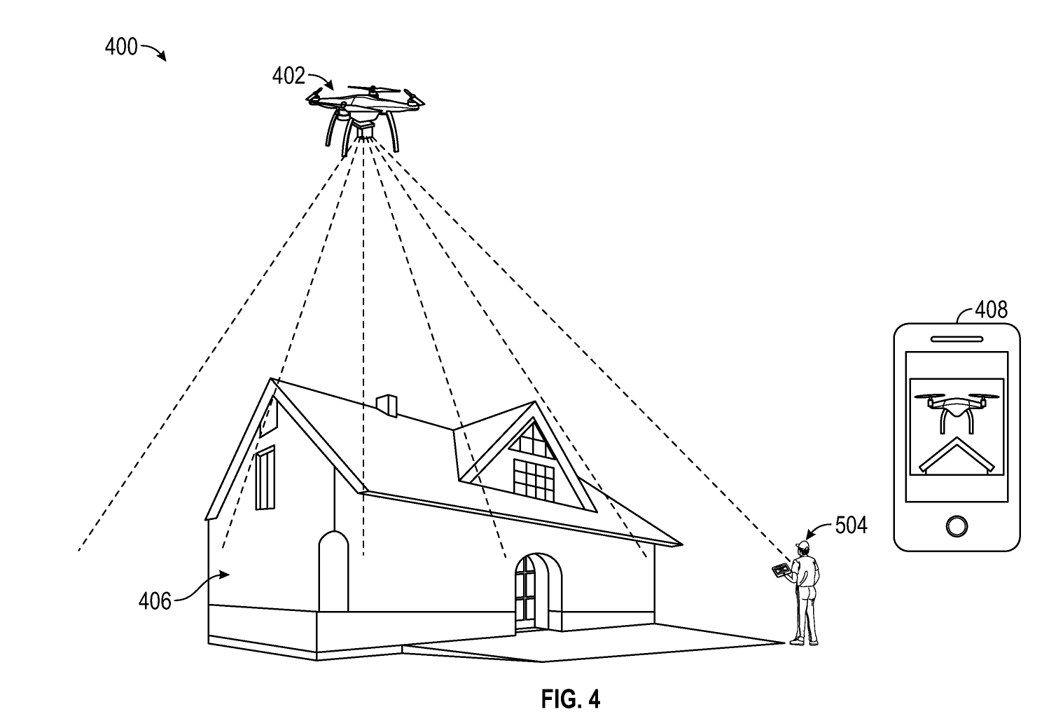

FIG. 4 is a diagram 400 illustrating an example of acquiring image data of a structure 406 using a UAV 402, in accordance with certain aspects of the present disclosure. As shown, an adjuster 404 who may also be a drone operator, may be present onsite. The adjuster 404 may directly control the UAV 402 or may monitor the UAV 402 as the UAV flies a preprogramed path. The UAV 402 may fly and capture images of the structure 406. This may be done by flying along a number of different flight path shapes and altitudes while capturing images of the structure 406. Further, as shown in, a digital device 408 may be used by the adjuster 404 to monitor or control the UAV 402 as shown. The portable digital device 408 may be a cellular phone (as shown), a tablet, or a laptop.

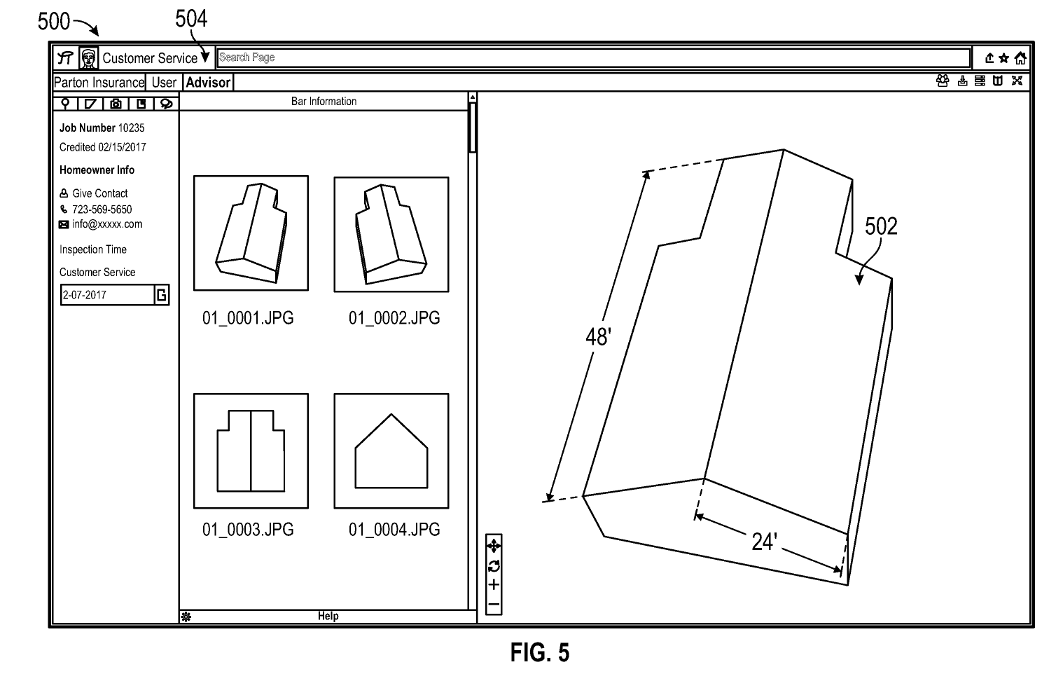

FIG. 5 illustrates an example of a 3-D model 500 of a structure, and a 3-D model GUI interface 504 in accordance with aspects of the present disclosure. Using the plurality of 2-D aerial images collected, the insurance data analytics platform may generate the 3-D model 500 of the structure. As shown, the 3-D model 500 may be generated such that the 3-D model 500 accounts each planar surface of the roof separately. For example, as shown in FIG. 5, one of the planar surface 502 of the roof is indicated. A measurements report of the 3-D model from FIG. 5 may be generated, in accordance with aspects of the present disclosure. The measurement report may show the length of each perimeter edge portion and seam of the roof of the structure. Other calculations may also be provided such as pitch and angles that define the roof contours and shape.

As shown, the 3-D model GUI interface 504 may include a menu of options on the far left portion of the interface. Next to that, the interface 504 may show the image data that includes all the 2-D aerial images collected. Further, in the large portion of the interface 504, the 3-D model that has been generated using the aerial imagery may be shown along with one or more roof sections selected. According to other cases, other GUI arrangements may be provided that still provide access to the 3-D model, aerial images, and option menu.

FIG. 5 also illustrates an example of calculating measurements of the 3-D model, in accordance with aspects of the present disclosure. As shown, different values of different parts of the roof may be calculated using one or more of the aerial images collected. The calculated values may then be superimposed onto the corresponding portion of the 3-D model as shown.

One or more measurements report of the 3-D model from FIG. 5 may be generated and provided, in accordance with aspects of the present disclosure. In one or more cases, the GUI interface may include multiple windows and information tables and images. For example, a first window may be provided that shows a top down image view of the overall structure as well as the specific external details and information about the structure in a table. Other windows may further show images and tables that display the location and length/size of other measurements of the roof such as perimeter length, seam lengths, pitch, and angles.

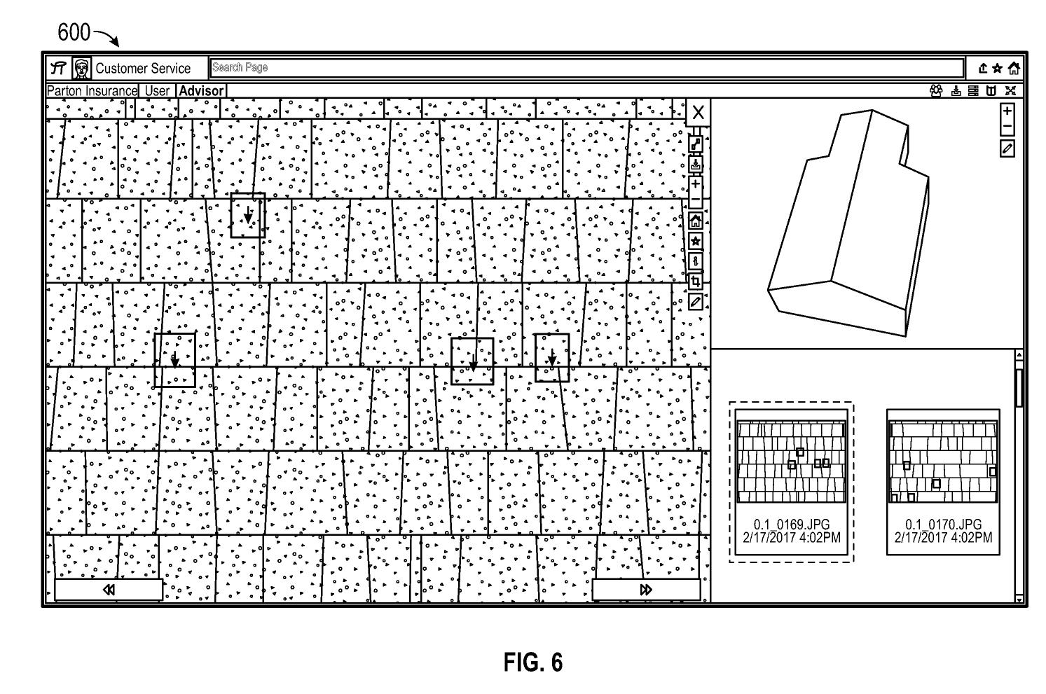

FIG. 6 illustrates an example of a damage report, damage report image(s), and a damage report GUI 600 for displaying the report and images, in accordance with aspects of the present disclosure. As shown, a close-up view is shown of a roof of a structure on the left side of the GUI. The image has been overlaid with damage indicator boxes that point out the detected points of damage that have been identified by the application and analytics done by the insurance data analytics platform. One or more features of the structure may be detected using one or more of the measurements, the 3-D model, the measurements, and the image data collected. The features may include damage points caused by hail, wind, mechanical issues, age, and wear and tear. The detected damage points may be outlined on the image with different visual cues such as using different colors, shapes, and patterns so that a user viewing the image can quickly identify the location of the type of feature/damage that is being shown. Additionally, the damage report GUI 600 may also include an overall top-view of the structure that shows all the damage points as well as a listing of other close-up views that show local damage points that a user can select from.

Insurance reports may be generated, in accordance with aspects of the present disclosure. These reports are generated by calculating a particular quantity of materials for addressing one or more of the damage points identified on the roof of the structure. For example, the damage point location, severity, and size are combined with information from roofers regarding cost of materials and services for particular replacement and repair procedures. This system can combine this information to generate an estimate of repair for the roof of the structure. The report can then be generated showing the specific breakdown of each material and repair actions along with their costs. This report can then be provided for viewing through the centralized portal so that roofers can request or accept the overall job as set out, the insurance companies can approve or adjust, and the policy holder can see and understand the extent of repair and replacement.

### Example of Image Data Acquisition by a UAV for an Insurance Data Analytics Project

Different structure types may be analyzed in accordance with one or more cases. For example, a first property may include a structure with a main building and one or more detached structures. Another property with one single main structure may be provided. Both structures are able to be captured and processed by the insurance data analytics platform to generate a report as described above.

According to one or more examples, a method of collecting image data may include taking two overhead images that cover the entire property, including main and detached structures, if there are any. The image may be taken by centering the UAV/drone over the house and maximizing the size of the house in the frame. Further, the image may be taken by centering the entire property in images. The height that this image is taken at will vary depending on the size of the structure. For example, a height is selected that maximizes the house area in the frame but also high enough to capture all of the structure. In another example, multiple images may be taken and stitched together if the involved height exceeds the UAVs capabilities or legal limits. This image is taken when the UAV is stationary over the house. The camera angle may be 90 degrees to ground.

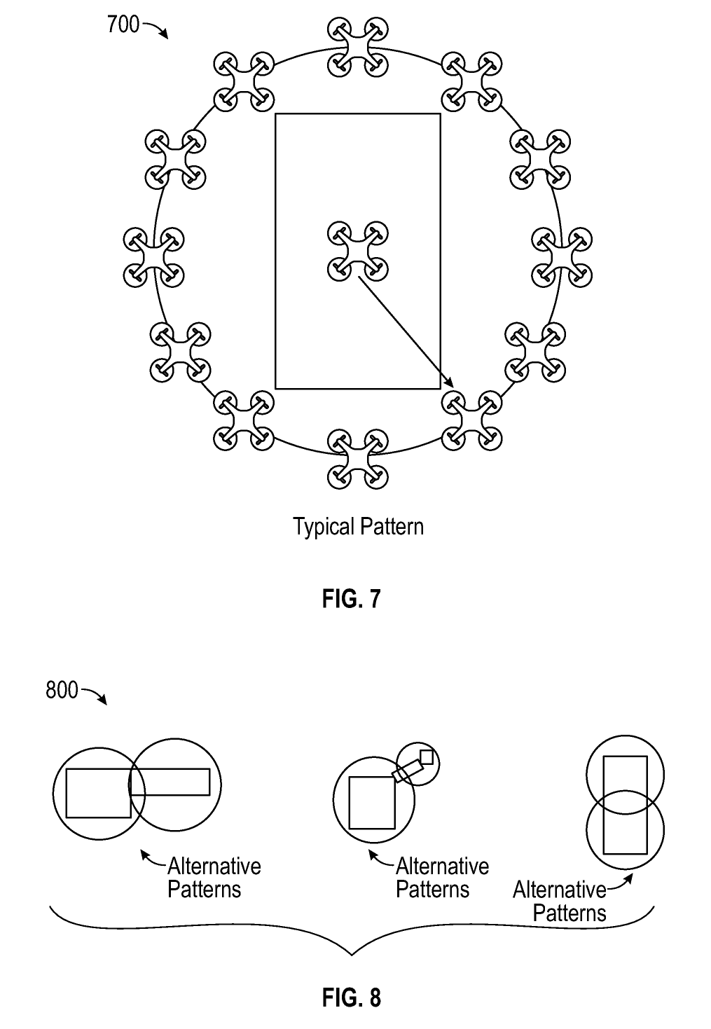

FIG. 7 illustrates an example of a perimeter flight path 700 for a UAV around a structure, in accordance with aspects of the present disclosure. A set of image data acquired from a perimeter flight path of a UAV may include a plurality of images of the structure, in accordance with aspects of the present disclosure.

For example, according to one or more cases, starting from the center point of the structure (e.g., a house), the UAV may move to one of the outside corners of the structure. The UAV may then fly in a 360 degree circular pattern around the structure at a speed of, for example, 1 mph. The UAV image device may acquire images every 5 seconds and at least a total of 24 images around the entire structure. This set of images may include images from the sides of the structure as well. When capturing images, the UAV may process images and flight pattern to ensure the top edge the roof is in every image and to keep the entire structure in the frame. To accomplish this, the UAV may adjust flight patterns due to the shape of the structure or obstructions in the flight path and multiple passes may be provided in one or more cases.

According to one example, the perimeter flight pattern may be at a height of 10 ft. above a highest point on the structure plus 3 to 5 ft. above any obstructions. The flight pattern may be circular and the camera angle may be approximately 40 to 45 degrees to ground. The UAV speed may be, for example, 1 mph and the image device may perform image acquisition at a rate of every 5 seconds.

FIG. 8 illustrates examples of multi-perimeter flight patterns 800 for a UAV, in accordance with aspects of the present disclosure. As shown, different structure shapes may be captured by flying multiple perimeter flights around different portions of an overall structure rather than flying one larger perimeter flight that may place the UAV farther than desired for image capture of the structure.

Further, in accordance with one or more examples, structures and obstructions on the properties may involve alternative flight patterns to capture the perimeter images. If necessary to adequately image the perimeter, the UAV may fly overlapping patterns similar to those shown in FIG. 8. According to one or more cases, the same considerations that apply to alternative perimeter flight patterns also may apply for the standard pattern.

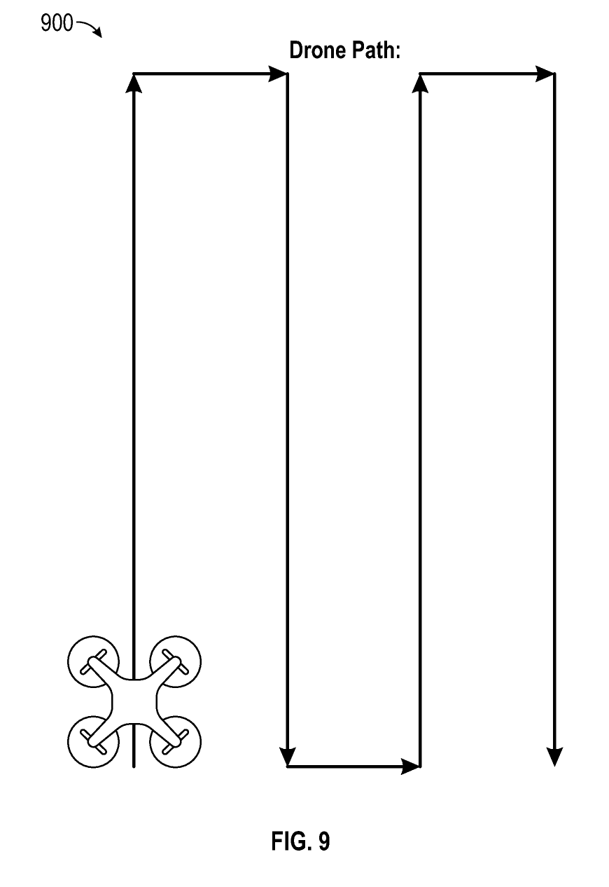

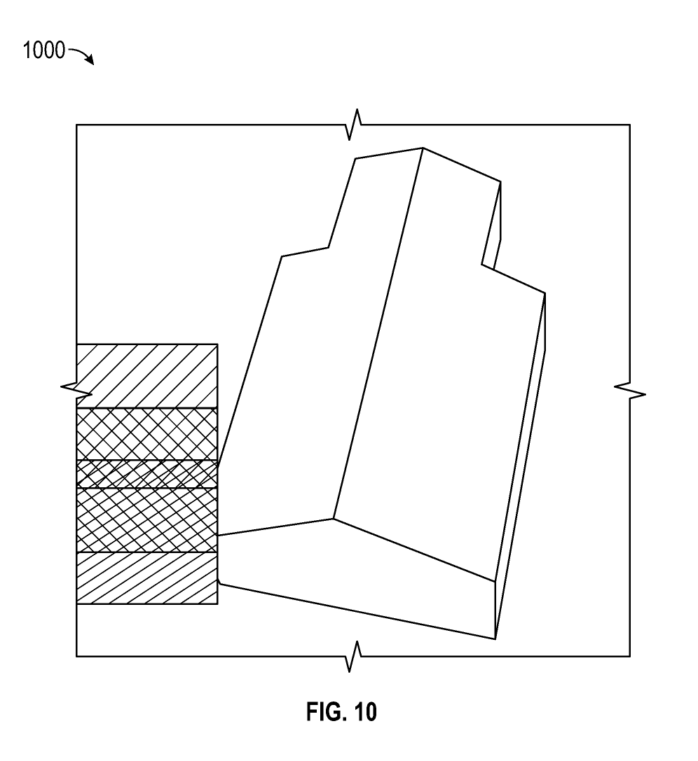

Further, FIG. 9 illustrates an example of a zig-zag flight pattern 900 for a UAV, in accordance with aspects of the present disclosure. FIG. 10 illustrates an example of an overlap image acquisition scheme 1000 when in a zig-zag flight pattern, in accordance with aspects of the present disclosure. Particularly, as shown, the UAV may be set to capture images such that each image covers a third of the area of the previous image captured to facilitate stitching of the images. A set of image data may be acquired from a zig-zag flight path of a UAV, in accordance with aspects of the present disclosure.

For example, a survey of the entire property, including the main and detached structures may be implemented using a zig-zag pattern along with overlapping image capture. The overlap may help ensure imaging transition regions between separate structures. In one or more cases failure to comply may lead to integrity issues for modeling. In one or more cases, the UAV flies within 10 ft. of the highest point on the roof but at a height sufficient to avoid all structural features and obstructions. Each image that is captured may overlap its neighboring images by for example 66%, or 10% to 80%. The height of the zig-zag pattern may be within 10 ft. of highest point of the roof and include the zig-zag with image overlap capture of 66%, for example, and the camera angle may be 90 degrees to ground.

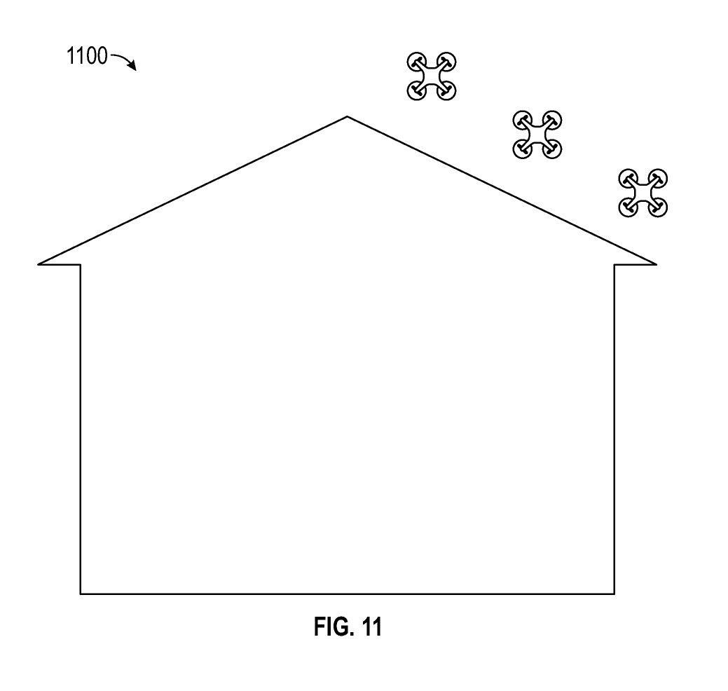

FIG. 11 illustrates an example of a close-up flight pattern 1100 of a UAV over a structure, in accordance with aspects of the present disclosure. An example of image data acquired from a close-up flight pattern of a UAV may include a sub-portion of a roof of a structure showing a number of shingles and detailed features, in accordance with aspects of the present disclosure.

For example, the UAV may fly in a zig zag pattern within 7-9 ft. of the roof following the slope of the roof. The camera capture device may ensure that the camera angle is 90 degrees or from 65 degrees to 115 degrees relative to the roof facet. According to one or more examples, each image may overlap its neighboring images by, for example, 25% or 10% to 80%. Further, an attempt to avoid photographing facets at a large, oblique angle may also be implemented in accordance with one or more cases.

An initial GUI screen for accessing a data analytics platform may be provided that includes a login screen that allows a user to input their identification credentials, in accordance with aspects of the present disclosure. Identification credentials may include an email address and a password. A job management GUI may be provided that includes a listing of accessible roof jobs along with details for each of the jobs that depend on the particular user, in accordance with aspects of the present disclosure. The job management GUI may be accessed after going through the initial GUI screen from any remote data entry point from which the user may be accessing the insurance data analytics platform. For example, the user may be using a computer at work or at home or while traveling. Further, the platform may be used by an adjuster who has captured image data to upload that image data. Particularly, the adjuster may use the selection and upload buttons and menus options as provide by the GUI to upload images acquired using, for example, a UAV or a cellular phone.

In one or more cases, a computer-implemented method for applying insurance data analytics to a structure to generate a report may be provided. The method may include generating an insurance analytics project based on a user input, acquiring image data of the structure based on the insurance analytics project, generating a 3-D model of the structure based on the image data, calculating measurements of the structure based on the 3-D model and image data, detecting one or more features of the structure using one or more of the measurements, the 3-D model, and the image data, and generating the report based on one or more of the user input, the image data, the 3-D model, the measurements, and the one or more features.

In some cases, generating the insurance analytics project may include receiving a request to generate an insurance analytics project from a user, posting the request via a request interface, and receiving an acceptance indication of the request for the insurance analytics project from an adjuster through the request interface.

In some cases, the user may be at least one of an insurance carrier, the adjuster, a home owner, a policy holder, a roofer, a contractor, or a weather service provider. The user input from the weather service provider may include weather data including one or more of hale damage areas, high wind areas, sever weather areas, weather severity information, weather date occurrence, and weather duration.

In some cases, receiving the request may include receiving a user input through a web portal that comprises an insertion GUI that provides input areas for a user to enter information including an address, and a job type, or receiving a user input in the form of an email that comprises parameters for generating the insurance analytics project.

In some cases, the method may further include assigning the insurance analytics project to the adjuster based on at least the acceptance indication.

In some cases, acquiring image data of the structure based on the insurance analytics project may include activating an unmanned aerial vehicle (UAV) that comprises an image capture device and a communication system for transferring captured image data, flying the UAV over the structure and collecting image data, and transmitting the image data to a central storage and processing entity.

In some cases, collecting image data may further include processing the image data, using a processing device on the UAV, as the image data is captured.

In some cases, flying the UAV over the structure and collecting image data may include flying to a top position over the structure, flying along a perimeter path around the structure at a lower altitude than the top position, flying along a zig-zag pattern over the structure at a lower altitude than the perimeter path, flying along a close-up route near the structure, and collecting one or more of images or a video while flying.

In some cases, flying the UAV over the structure and collecting image data may include flying to a top position that is 400 or more feet over the structure, and acquiring an overall top-down image of the structure from the top position.

In some cases, flying the UAV over the structure and collecting image data may include flying along a perimeter of the structure around 60 feet off the ground, and collecting a plurality of birds-eye-view images.

In some cases, flying the UAV over the structure and collecting image data may include flying in a zig-zag pattern over the structure between 30 and 60 feet off the ground, and collecting a plurality of zig-zag images.

In some cases, flying the UAV over the structure and collecting image data may include flying 6 to 10 feet from the structure along the structure, and collecting a plurality of close-up images of the structure.

In some cases, the plurality of close-up images may include images of an entire roof of the structure when the structure is at least one of a home residence or images of select portions of the roof of the structure when the structure is a commercial building. The select portions may include one or more of roof seams, roof vents, and roof attached HVAC units.

In some cases, acquiring image data of the structure based on the insurance analytics project may include acquiring image data using a mobile device that includes an image sensor and a communication system.

In some cases, the mobile device may include a GUI that includes a plurality of input screens. The plurality of input screen may include, but are not limited to: a job selection screen that allows a user to select a job from among a plurality of available jobs; an image type capture screen that provides a list of image types to capture for a selected job; an image preview screen for each of the image types that shows a preview of any images that have been captured or an indicator that indicates no image has yet been captured; and an auxiliary input screen where a user types in additional information including one or more of location, time, materials, conditions of structure, or image notes.

In some cases, the image data may include one or more of downspouts, windows, doors, walls, and AC units.

In some cases, the user input may include one or more of home materials, age of home, components of home, previous real-estate transaction information, city permit information, and city inspection information.

In some cases, the image data may include one or more of digital images, thermal images, video, infrared images, or multispectral images.

In some cases, generating the 3-D model of the structure based on the image data may include collecting the image data and user input at a central storage and processing entity, selecting one or more images from the image data for generating the 3-D model of the structure, and generating the 3-D model using the selected one or more images by generating a point cloud based on one or more of the selected images, and texturing and coloring the point cloud using one or more of the selected images.

In some cases, generating the 3-D model of the structure based on the image data may include stitching together multiple images to generate a composite image.

In some cases, calculating measurements of the structure may include calculating measurements that include one or more of dimensions of a roof of the structure, pitch of each planar portion of the roof of the structure, seam location, roof materials, and one or more panels installed on the roof.

In some cases, detecting the one or more features of the structure may include detecting one or more features that include one or more of damage points on the roof of the structure, damage type of each damage point, and damage point properties, or detecting one or more features that include solar panels, vents, AC units, and gutters.

In some cases, detecting the one or more features of the structure may include training a deep learning model to identify and classify damages to the structure. The deep learning model may be trained using at least one or more sets of images that each depicts a distinct type of structure damage and a set of images depicting undamaged structures.

In some cases, generating the report may include identifying one or more issues with the structure corresponding to the one or more features detected, and determining a scope of the issues of the structure, wherein the scope includes an estimation of different types of repairs and costs for those repairs for remedying the one or more issues.

In some cases, generating the report may include populating the report with one or more of structure conditions including a damage report, a weather report, an image report showing images that correspond to damage points in the damage report, a scope of work report that includes an estimation of different types of repairs and costs for those repairs, and a measurement report that shows the measurements overlaid on the 3-D model.

In some cases, generating the report may include integrating and matching additional information with the image data. The additional information may include information provide by one or more roofers including bid amounts for different types of repairs and materials.

In some cases, generating the report may include generating an image report that includes images showing damage to the roof of the structure.

In some cases, generating the image report may include selecting an image that corresponds to one or more of the one or more features detected, adding one or more graphical indications to the image to call out damage points, and adjusting image properties to enhance the one or more features for improved visual identification.

In some cases, the method may further include displaying related images to the image showing damage, and superimposing the images showing damage onto the 3-D model.

In some cases, the method may further include converting the report into an insurance claim that includes an identification of one or more issues and a calculated amount to address the issues.

The methods described herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). As used herein, including in the claims, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” For example, the articles “a” and “an” as used in this application and the appended claims should generally be construed to mean “one or more” unless specified otherwise or clear from the context to be directed to a singular form. Unless specifically stated otherwise, the term “some” refers to one or more. Moreover, the term “or” is intended to mean an inclusive “or” rather than an exclusive “or.” That is, unless specified otherwise or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. All structural and functional equivalents to the elements of the various aspects described throughout this disclosure that are known or later come to be known to those of ordinary skill in the art are expressly incorporated herein by reference and are intended to be encompassed by the claims. Moreover, nothing described herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1); a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, phase change memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in the appended figures.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A computer-implemented method for applying insurance data analytics to a structure to generate a report, comprising:
generating an insurance analytics project based on a user input;
acquiring image data of the structure based on the insurance analytics project;
generating a 3-D model of the structure based on the image data;
calculating measurements of the structure based on the 3-D model and image data;
detecting one or more features of the structure using one or more of the measurements, the 3-D model, and the image data; and
generating the report based on one or more of the user input, the image data, the 3-D model, the measurements, and the one or more features.

2. The method of claim 1, wherein generating the insurance analytics project comprises:
receiving a request to generate an insurance analytics project from a user;
posting the request via a request interface; and
receiving an acceptance indication of the request for the insurance analytics project from an adjuster through the request interface.

3. The method of claim 2,
wherein the user is at least one of an insurance carrier, the adjuster, a home owner, a policy holder, a roofer, a contractor, or a weather service provider, and
wherein the user input from the weather service provider includes weather data including one or more of hale damage areas, high wind areas, sever weather areas, weather severity information, weather date occurrence, and weather duration.

4. The method of claim 2, wherein receiving the request comprises:
receiving a user input through a web portal that comprises an insertion GUI that provides input areas for a user to enter information including an address, and a job type, or
receiving a user input in the form of an email that comprises parameters for generating the insurance analytics project.

5. The method of claim 2, further comprises:
assigning the insurance analytics project to the adjuster based on at least the acceptance indication.

6. The method of claim 1, wherein acquiring image data of the structure based on the insurance analytics project comprises:
activating an unmanned aerial vehicle (UAV) that comprises an image capture device and a communication system for transferring captured image data;
flying the UAV over the structure and collecting image data; and
transmitting the image data to a central storage and processing entity.

7. The method of claim 6, wherein collecting image data further comprises:
processing the image data, using a processing device on the UAV, as the image data is captured.

8. The method of claim 6, wherein flying the UAV over the structure and collecting image data comprises:
flying to a top position over the structure;
flying along a perimeter path around the structure at a lower altitude than the top position;
flying along a zig-zag pattern over the structure at a lower altitude than the perimeter path;
flying along a close-up route near the structure; and
collecting one or more of images or a video while flying.

9. The method of claim 6, wherein flying the UAV over the structure and collecting image data comprises:
flying to a top position that is 400 or more feet over the structure; and
acquiring an overall top-down image of the structure from the top position.

10. The method of claim 6, wherein flying the UAV over the structure and collecting image data comprises:
flying along a perimeter of the structure around 60 feet off the ground; and
collecting a plurality of birds-eye-view images.

11. The method of claim 6, wherein flying the UAV over the structure and collecting image data comprises:
flying in a zig-zag pattern over the structure between 30 and 60 feet off the ground; and
collecting a plurality of zig-zag images.

12. The method of claim 6, wherein flying the UAV over the structure and collecting image data comprises:
flying 6 to 10 feet from the structure along the structure; and
collecting a plurality of close-up images of the structure,
wherein the plurality of close-up images includes images of an entire roof of the structure when the structure is at least one of a home residence or images of select portions of the roof of the structure when the structure is a commercial building, and
wherein the select portions include one or more of roof seams, roof vents, and roof attached HVAC units.

13. The method of claim 1, wherein acquiring image data of the structure based on the insurance analytics project comprises:
acquiring image data using a mobile device that includes an image sensor and a communication system,
wherein the mobile device includes a GUI that includes a plurality of input screens including:
a job selection screen that allows a user to select a job from among a plurality of available jobs;
an image type capture screen that provides a list of image types to capture for a selected job;
an image preview screen for each of the image types that shows a preview of any images that have been captured or an indicator that indicates no image has yet been captured; and
an auxiliary input screen where a user types in additional information including one or more of location, time, materials, conditions of structure, or image notes.

14. The method of claim 1, wherein the user input includes one or more of home materials, age of home, components of home, previously real-estate transaction information, city permit information, and city inspection information.

15. The method of claim 1, wherein generating the 3-D model of the structure based on the image data comprises:
collecting the image data and user input at a central storage and processing entity, selecting one or more images from the image data for generating the 3-D model of the structure, and generating the 3-D model using the selected one or more images by generating a point cloud based on one or more of the selected one or more images, and texturing and coloring the point cloud using one or more of the selected images, or.
stitching together multiple images to generate a composite image.

16. The method of claim 1, wherein calculating measurements of the structure comprises:
calculating measurements that include one or more of dimensions of a roof of the structure, pitch of each planar portion of the roof of the structure, seam location, roof materials, and one or more panels installed on the roof.

17. The method of claim 1, wherein detecting the one or more features of the structure comprises:
training a deep learning model to identify and classify damages to the structure, wherein the deep learning model is trained using at least one or more sets of images that each depicts a distinct type of structure damage and a set of images depicting undamaged structures; and
detecting one or more features that include one or more of damage points on the roof of the structure, damage type of each damage point, and damage point properties, or detecting one or more features that include solar panels, vents, AC units, and gutters.

18. The method of claim 1, wherein generating the report comprises:
identifying one or more issues with the structure corresponding to the one or more features detected;
determining a scope of the issues of the structure, wherein the scope includes an estimation of different types of repairs and costs for those repairs for remedying the one or more issues; populating the report with one or more of structure conditions including a damage report, a weather report, an image report showing images that correspond to damage points in the damage report, a scope of work report that includes an estimation of different types of repairs and costs for those repairs, and a measurement report that shows the measurements overlaid on the 3-D model; and integrating and matching additional information with the image data, wherein the additional information includes information provide by one or more roofers including bid amounts for different types of repairs and materials.

19. The method of claim 1, wherein generating the report comprises:
generating an image report that includes images showing damage to the roof of the structure by selecting an image that corresponds to one or more of the one or more features detected, adding one or more graphical indications to the image to call out damage points, and adjusting image properties to enhance the one or more features for improved visual identification;
displaying related images to the images showing damage; and
superimposing the images showing damage onto the 3-D model.

20. The method of claim 1, further comprising:
converting the report into an insurance claim that includes an identification of one or more issues and a calculated amount to address the issues.
